(19) United States
(12) Patent Application Publication
(10) Pub. No.: US 2009/0293350 A1
(43) Pub. Date: Dec. 3, 2009

(54) RAISED BED PLANTER WITH BIOMIMETIC EXOSKELETON

(75) Inventors: Bruce G. Kania, Shepherd, MT (US); Frank M. Stewart, Bozeman, MT (US)

Correspondence Address: ANTOINETTE M. TEASE, P. O. BOX 51016, BILLINGS, MT, 59105, US

(73) Assignee: Fountainhead, LLC, Shepherd, MT (US)

(21) Appl. No.: 12/436,755

(22) Filed: May 6, 2009

Related U.S. Application Data
(60) Provisional application No. 61/103,558, filed on Oct. 7, 2008.
(60) Provisional application No. 61/056,271, filed on May 27, 2008.

(51) Int. Cl. A01G 9/02; A01G 25/00; A01G 25/16; A01G 13/02

(52) U.S. Cl. 47/29.1; 47/65.7; 47/81; 47/79; 47/82; 47/86; 47/20.1; 47/29.5

(57) ABSTRACT

A raised bed planter comprising a porous and permeable load-bearing exoskeleton comprised of nonwoven polymer matting and a spray-on polymer coating; a core section comprised of hydrophilic bedding fill material; and a bottom layer that serves as a weed barrier. The planter optionally incorporates multiple bedding levels and/or a wicking system or wicking components. In an alternate embodiment, the exoskeleton is comprised of a layer of outdoor carpet, a layer of fencing material, and a layer of nonwoven polymer matting. The planter optionally comprises one or more wings and a removable greenhouse cover.

### CROSS-REFERENCE TO RELATED APPLICATION

This application claims priority under 35 U.S.C. §119(e) back to U.S. Patent Application No. 61/056,271 filed on May 27, 2008 and U.S. Patent Application No. 61/103,558 filed on Oct. 7, 2008.

### BACKGROUND OF THE INVENTION

1. Field of the Invention

The present invention relates generally to the field of horticulture, and more specifically, to a raised bed planter for growing edible and decorative plants above natural ground level.

2. Description of the Related Art

Traditional planters are limited in that their designs are usually fairly rigid (for example, they do not allow for freeform shapes, nor do they allow for large and/or interlocking shapes), the structures of the planters may not be portable or durable, and they do not adequately deal with drainage of excess moisture. Furthermore, the interior fill of most prior art planters does not provide for moisture retention and wicking. Examples of prior art planters are discussed below.

U.S. Pat. No. 7,159,358 (Yawney et al., 2007) describes a wheeled, indoor gardening station, which comprises a removable plastic tray with drain holes.

U.S. Pat. No. 6,434,882 (Becker, 2002) provides a modular, raised-bed containment system comprised of rails that are stacked to increase the wall height. The rails may be comprised of a variety of materials, including recycled plastic. This patent involves only the outer containment walls for a raised-bed planter.

U.S. Pat. No. 6,399,185 (Cathey, 2002) discloses an organic substrate comprised of recycled paper, cotton and gypsum that may be used to prevent weed growth or act as a seed carrier substrate.

U.S. Pat. No. 5,400,544 (Wein, 1995) involves raised garden bed comprising a plant growth substrate that is sandwiched between two grid layers. U.S. Pat. No. 5,345,713 (Molnar et al., 1994) describes a sod mat comprised of polypropylene spunbound fabric that contains an optional hydrophilic treatment. The sod mat is covered by a planting medium.

U.S. Pat. No. 5,245,786 (Sorrow, 1993) provides a planter with vertically stacked tiers that may be disassembled and reassembled. The planter boxes are comprised of fiberglass, wood or aluminum, and are shown with straight sides.

U.S. Pat. No. 5,168,678 (Scott, Jr. et al., 1992) discloses a modular landscaping system comprised of landscaping logs that are connected with vertical pins to form walls.

U.S. Pat. No. 4,237,653 (Cortez, 1980) involves a plant growing box with sloping outer walls and beveled corners.

U.S. Pat. No. D536,584 (Petty, 2007) covers the design for a containment wall comprised of rails and pins.

U.S. Patent Application Pub. No. 20070089357 (Bowdish) describes a method for implementing a system of any intentional horticultural structure through a process utilizing a single portable platform component and a design template specification. The platform may optionally be augmented by adding a surface layer, cover or container and/or growth media.

U.S. Patent Application Pub. No. 20070130824 (Teich) provides a raised-bed frame that incorporates a pest-resistant fence, internal walkways, a water delivery system, a bird net, and a sunshade.

U.S. Patent Application Pub. No. 20060156626 (Seaman) discloses a raised-bed planter body having an open bottom end and a gardener's seat, with optional pest and weed barriers on the bottom. An optional soaker-hose watering system is included.

What is needed is a planter that is portable, durable and inexpensive, may be manufactured in a variety of regular or freeform shapes of any size, and comprises a rigid load-bearing exoskeleton that mimics the plant nurturing characteristics of natural soils. These desirable “biomimetic” characteristics include thermal insulation to avoid sudden temperature swings in the root zone of the plants, permeability for transport of water and atmospheric gases to the root zone, and drainage of excess water from the root zone to prevent flooding.

Accordingly, it is an object of the present invention to provide a planter that is modular and lightweight and, therefore, easy to transport and deploy. It is a further object of the present invention to provide a planter that has the ability to mimic the beneficial plant growing characteristics of natural soils.

It is a further object of the present invention to provide a planter having a porous and permeable exoskeleton that is comprised of nonwoven polymer fiber matting. It is a further object of the invention that fiber matting is injected and/or coated with cured-in-place polymers that beneficially modify the characteristics of the fiber matting by increasing its rigidity, reducing its permeability and optionally increasing its insulation value, thereby improving the plant nurturing properties of the planter. For example, by providing the bedding material with relatively stable temperatures at proper moisture levels, while simultaneously allowing atmospheric nitrogen gas and oxygen to flow through the exoskeleton to the bedding material, conditions are established for the growth of a symbiotic community of mychorrizae fungi, nitrogen-fixing bacteria, and plant roots, thereby resulting in optimum conditions for healthy plants.

Yet another object of the present invention is to provide a planter that can be constructed in a wide variety of shapes and heights for specialty applications such as wind barriers or visual barriers.

Yet another object of the present invention is to optionally provide a planter that supplies plants with water for extended periods by means of a reservoir and capillary water delivery system. It is a further object of the invention that the capillary water delivery system is able to transport water in any direction (upward, downward, horizontally, or diagonally) at a controlled flowrate that delivers water at an optimal rate to plants growing within the planter. It is a further object of the present invention to optionally provide a planter with multiple levels of individual growing beds that may contain different amounts of soil moisture, so that plants with different moisture requirements (e.g., dessert plants, upland plants, and wetland plants) may be grown simultaneously in different beds within the same planter. It is a further object of the present invention to be optionally constructed with a flat, rigid rear face in order that it can be installed on inclined or vertical surfaces, such as roofs or walls. It is a further object of the present invention to provide a planter that drains naturally and, therefore, cannot be flooded by over-watering.

It is a further object of the present invention to optionally provide individual planter modules comprised of multiple units that can be interlocked in both vertical and horizontal dimensions to form larger planter assemblies. Yet another object of the present invention is to provide a planter with all or some of these features that can be used to easily grow plants on infertile or inhospitable ground, cement or pavement.

It is a further object of the present invention to provide an enhanced plant nurturing habitat in which all the critical features of plant growth and health are optionally provided simultaneously within a raised bed planter. These critical parameters include temperature range, moisture level, gas transport rate, resistance to weeds, and optional resistance to pest animals.

It is a further object of the invention to optionally provide a planter with raised beds of sufficient height above ground surface to prevent animals such as rabbits from gaining access to plants growing within the beds.

It is a further object of the invention that it can optionally be constructed so as to serve as a decorative landscaping object (e.g., a synthetic rock, a synthetic earth mound, or a “living wall”) in addition to serving as a planter.

It is a further object of the invention that it may be optionally shipped in unassembled form, and then readily assembled by a distributor or end user, thereby reducing shipping costs.

### BRIEF SUMMARY OF THE INVENTION

The present invention is a raised bed planter comprising: a porous and permeable load-bearing exoskeleton comprised of nonwoven polymer matting and a spray-on polymer coating; a core section comprised of hydrophilic bedding fill material; and a bottom layer that serves as a weed barrier. In a preferred embodiment, the exoskeleton further comprises injected foam insulation.

In a preferred embodiment, the exoskeleton comprises seams between adjoining layers of nonwoven polymer matting, and the seams are joined with a bonding agent. In an alternate embodiment, the exoskeleton comprises seams between adjoining layers of nonwoven polymer matting, and the seams are joined with mechanical fasteners.

In a preferred embodiment, the exoskeleton further comprises sand or grit to deter chewing damage from rodents. In an alternate embodiment, the raised bed planter further comprises an exterior layer of indoor/outdoor carpeting to add protection against wind desiccation while providing a cosmetic benefit.

In a preferred embodiment, the raised bed planter further comprises wicking channels that transport water at a controlled rate in any direction to plants growing within the planter. In an alternate embodiment, the raised bed planter further comprises wicking components that transport water at a controlled rate in any direction to plants growing within the planter. The raised bed planter preferably further comprises a reservoir for storing the water that is transported by the wicking channels and/or wicking components.

In a preferred embodiment, the nonwoven polymer matting is comprised of polyester fibers that are intertwined to form a randomly oriented blanket. Preferably, a water-based latex binder is baked onto the polyester fibers to increase stiffness and durability of the blanket. In an alternate embodiment, the nonwoven polymer matting is comprised of recycled scrap material. Preferably, the recycled scrap material is selected from the group consisting of polyethylene terephthalate beverage bottles, polyethylene terephthalate carpet fibers, and high-density polyethylene milk jugs.

In a preferred embodiment, the spray-on polymer coating is a two-part polyurea resin. In another preferred embodiment, the injected foam insulation is polyurethane foam.

In a preferred embodiment, the bottom layer is comprised of a weed barrier material and a layer of porous and permeable load-bearing exoskeleton comprised of nonwoven polymer matting and a spray-on polymer coating. In an alternate embodiment, the nonwoven polymer matting of the exoskeleton is replaced with a nonwoven matting that is partially or completely comprised of one or more natural materials. Preferably, the natural material(s) is/are selected from the group consisting of coir, jute and cotton.

In a preferred embodiment, the exoskeleton is comprised of a plurality of pieces of exoskeleton that are bonded together with an adhesive. In an alternate embodiment, the exoskeleton is comprised of a plurality of pieces of exoskeleton that are fastened together with mechanical fasteners.

In a preferred embodiment, the hydrophilic bedding fill material is lightweight, durable, hydrophilic and nontoxic to plant roots. Preferably, the hydrophilic bedding fill material comprises peat, ground bark, rockwool, perlite, coir, jute, cellulose sponge, pumice, silica and/or cotton. In an alternate embodiment, a non-hydrophilic filler is added to the bedding material to reduce cost and/or weight.

In a preferred embodiment, the raised bed planter is constructed with a flat panel rear wall for installation on a wall, roof, fence or building. In another preferred embodiment, the weed barrier material is permeable to water. In an alternate embodiment, the weed barrier material is impermeable to water.

In a preferred embodiment, the sand or grit is adhered to the exoskeleton by sprinkling it onto uncured tacky polymer coating immediately after it has been applied to the nonwoven polymer matting. In an alternate embodiment, the sand or grit is mixed with paint and brushed over the exoskeleton.

In a preferred embodiment, the raised bed planter further comprises foam nodules that are injected into the exoskeleton. In another preferred embodiment, the raised bed planter comprises an inner section and an outer section, thereby providing two different growing environments. Preferably, the outer section comprises a bottom and the planter further comprises a bottom cup that is impermeable to water and that provides a zone of water-saturated soil in the bottom of the outer section.

In a preferred embodiment, the raised bed planter further comprising a hydrophilic insert, capillary wicking channels and fiber wool fill; each wicking channel has a top portion; and the wicking channels transport water vertically upward from the hydrophilic insert to plants that are growing near the top portion of the wicking channels and that grow through holes cut through the exoskeleton. Preferably, the hydrophilic insert and wicking channels are comprised of materials that are lightweight, durable, hydrophilic, and nontoxic to plant roots.

In a preferred embodiment, the fiber wool fill is comprised of scrap pieces of nonwoven polymer matting that has been chopped or shredded. In an alternate embodiment the fiber wool fill is comprised of coir, jute, cotton, rockwool, fiberglass, polymer foam, shredded rubber, or any combination of these materials.

In a preferred embodiment, the holes through which the plants grow are sloped so that water falling onto the exoskeleton flows by gravity into a nearby wicking channel, thereby supplying water to the plants and the hydrophilic insert. In another preferred embodiment, the raised bed planter further comprises a horizontal wicking system. Preferably, bedding pockets are formed by cutting holes through the exoskeleton; the horizontal wicking system comprises a collection basin, a runoff channel, and a reservoir; and water is transported from the reservoir to the bedding pocket by a wicking component.

In a preferred embodiment, the wicking component is comprised of compressed rockwool, cotton cloth, or other hydrophilic material. In an alternate embodiment, the wicking component is comprised of polymer pipe that has been packed with compressed rockwool, cotton fibers, or other hydrophilic material.

In a preferred embodiment, the wicking component is constructed within, partially within, or underneath the exoskeleton. In another preferred embodiment, the raised bed planter comprises multiple planting beds at different levels relative to the bottom layer. In an alternate embodiment, the exoskeleton is shaped so as to fit into a corner of a building, fence, or any other structure with a corner.

In a preferred embodiment, the exoskeleton further comprises a strengthening material, and the strengthening material is selected from the group consisting of shotcrete, polyurethane foam, polyurethane, polyurea, construction adhesive, silicone and plastic wood filler. In an alternate embodiment, the raised bed planter has an overall weight, and the planter further comprises internal baffles to reduce the overall weight of the planter. Preferably, the internal baffles are comprised of polystyrene, polyurea-coated nonwoven polymer matting, or polyurethane foam.

In a preferred embodiment, the raised bed planter further comprises drain tubes that drain excess water from one planting bed to a lower planting bed. Preferably, one of the planting beds is the lowest planting bed, and water that drains through the drain tubes to the lowest planting bed is drained through outlet tubing when a drain valve is temporarily opened.

In a preferred embodiment, each planting bed comprises inner walls and a bottom; and each planting bed comprises impermeable bed liners installed along the inner walls and the bottom of the planting bed to prevent water from escaping from one planting bed to another. Preferably, the bed liners are comprised of polyurethane, polyurea, or polypropylene.

In a preferred embodiment, portions of the exoskeleton are covered with outdoor carpeting to reduce moisture losses and/or for decorative purposes. In another preferred embodiment, each raised bed planter forms an interlocking planter unit that is joined to another interlocking planter unit by means of a tongue that fits into a groove in an adjoining interlocking planter; and the interlocking planter units are attached to a wall, fence or roof with a mounting plate that is attached to the interlocking planter units.

In an alternate embodiment, the present invention is a raised bed planter comprising: an exoskeleton comprised of a layer of outdoor carpet, a layer of fencing material, and a layer of nonwoven polymer matting; a core section comprised of hydrophilic bedding fill material; and a bottom layer that serves as a weed barrier. landscaping fabric, woven or nonwoven polymer sheeting, metal sheeting or metal fencing. The support rod is preferably comprised of wood, steel, aluminum, fiberglass, polyvinyl chloride, or high-density polyethylene.

In a preferred embodiment, the present invention further comprises a removable greenhouse cover; the planter has a center; the greenhouse cover is supported by the wings that extend outward from the exoskeleton of the planter and by at least one vertical pole that extends from the ground surface upward through the center of the planter or in between one or more adjacent planters; and the greenhouse cover extends downward to or near to the ground surface. In an alternate embodiment, each wing has an outer edge, and the greenhouse cover extends downward to the outer edges of the wings. Preferably, the greenhouse cover is comprised of polyethylene sheeting, fiberglass, acrylic or glass panels, woven polypropylene fabric, or polymer netting.

### BRIEF DESCRIPTION OF THE DRAWINGS

FIG. 1 is a perspective view of a first embodiment of the present invention.

FIG. 2 is a cross-section side view of a first embodiment of the present invention.

FIG. 3 is a detailed schematic cross section view of a portion of the exoskeleton of the planter, showing the polymer coating, optional foam insulation, and optional sand coating animal deterrent.

FIG. 4 is a perspective view of a second embodiment of the present invention comprising a

FIG. 5 is a cross-section side view of a “green rock” embodiment of the present invention comprising a vertical wicking system.

FIG. 6 is a partial cross-section side view of an alternate “green rock” embodiment comprising a horizontal wicking system.

FIG. 7 is a perspective view of a freeform-shaped embodiment of the present invention.

FIG. 8 is a perspective view of an alternate embodiment of the present invention in which the planter has flat sides.

FIG. 9 is a perspective view of the multi-level planter embodiment of the present invention.

FIG. 10 is a cross-section side view of the multi-level planter embodiment.

FIG. 11 is an exploded perspective view of two interlocking “green wall” planter units.

FIG. 12 is a partial plan cross-section view of two vertical walls of a planter that have been joined by a tongue-and-groove fitting.

FIG. 13 is a partial plan cross-section view of two vertical walls of a planter that have been joined by a double-ended barbed pin.

FIG. 14 is a partial plan cross-section view of two vertical walls of a planter that have been joined by hook-and-loop fasteners.

FIG. 15 is an alternate embodiment of the hook-and-loop fastener system shown in FIG. 14.

FIG. 16 is an alternate embodiment of a planter exoskeleton with a stiffener layer.

FIG. 17 is a cross-section view of a plurality of planters that comprises optional “wings” or extensions.

FIG. 18 is a cross-section view of a circular array of planters with a first embodiment of a removable greenhouse cover.

FIG. 19 is a cross-section view of a planter with a second embodiment of a removable greenhouse cover.

### REFERENCE NUMBERS

1 Raised bed planter
2 Exoskeleton
3 Seam (of exoskeleton)
4 Bonding agent
5 Hydrophilic bedding fill material
6 Bottom layer
7 Plant
8 Weed barrier layer
9 External water supply
10 Arrow representing gas flow
11 Arrow representing water flow
12 Fibers in nonwoven polymer matting
13 Pore spaces in nonwoven polymer matting
14 Polyurea coating
15 Injected foam insulation
16 Sand or grit particles
17 Planter short section
18 Planter long section
19 Bottom cup
20 Green rock embodiment, green rock planter
21 Hydrophilic insert
22 Wicking channel
23 Fiber wool fill
24 Bedding pocket
25 Collection basin
26 Reservoir
27 Runoff channel
28 Arrow showing water flow
29 Wicking component
29 Multi-level planter
30 Upper bed
31 Middle bed
32 Lower bed
33 Internal baffle
34 Drain tube
35 Bed liner
36 Internal tray
37 Outlet tubing
38 Drain valve
39 Interlocking planter unit
40 Mounting plate
41 Tongue
42 Groove
43 Single-ended barbed pin
44 First exoskeleton segment
45 Second exoskeleton segment
46 Locking pin assembly
47 Double-ended barbed pin
48 Edge hole
49 Hook portion (of hook-and-loop fastener)
50 Loop portion (of hook-and-loop fastener)
51 Layer of outdoor carpet
52 Layer of fencing material
53 Layer of nonwoven polymer matting
54 Wing (or extension)
55 Support rod
56 Support bracket
57 Ground
58 Greenhouse cover
59 Center pole
60 Lower edge of greenhouse cover
61 Internal space
62 Greenhouse cover (short-sided)

### DETAILED DESCRIPTION OF INVENTION

The present invention is comprised of three main components: (1) a porous and permeable load-bearing exoskeleton having biomimetic properties, the exoskeleton being comprised of a combination of nonwoven polymer matting, a spray-on polymer coating, and optional injected foam insulation; (2) a core section of hydrophilic bedding fill material for retaining moisture at optimal levels while simultaneously draining excess water away from the plant roots in order to optimize growing conditions; and (3) a bottom layer that provides a weed barrier. The invention optionally comprises one or more of the following components: (1) a bonding agent or mechanical fasteners to join seams of the exoskeleton; (2) sand or grit to deter chewing damage from rodents; (3) an exterior layer of outdoor carpeting to add protection against wind desiccation while providing a cosmetic benefit; (4) wicking channels or wicking components that transport water at a controlled rate in any direction (upward, downward, horizontally, or diagonally) to the plants growing within the planter; and (5) a reservoir to store water and provide this water to the wicking components.

The nonwoven polymer matting component of the exoskeleton is preferably comprised of polyester fibers that are intertwined to form a randomly oriented web or “blanket” with a standard thickness and width. One manufacturer of suitable nonwoven matting material is Americo Manufacturing Incorporated of Acworth, Ga. In a preferred embodiment, the matting is comprised of 200-denier polyester fibers that are intertwined to form a blanket approximately 1¾ inch thick by 56 inches wide. The matting is produced in a continuous strip and cut to lengths of approximately 90 feet for shipping. The nominal weight of the blanket is 41 ounces per square yard. The nominal weight of the polyester fibers within the blanket is 26 ounces per square yard. A water-based latex binder is baked onto the fibers to increase the stiffness and durability of the blanket (this is not the same as the spray-on polymer coating described below). The characteristics of the matting can be adjusted by varying the construction materials and manufacturing process. For example, the diameter of the fibers may be varied from approximately 6 to 300 denier. Coarse fibers result in a relatively stiff matting, while fine fibers result in a relatively flexible matting. The latex binder can be applied relatively lightly or relatively heavily to vary the durability and weight of the matting, and dye or pigment can be added to the binder to produce a specific color of matting. The thickness of the blanket can be adjusted from approximately ¼-inch to 4 inches using current manufacturing techniques. It is anticipated that thicker blankets will be produced in the future, and these thicker blankets (for example, 5 to 12 inches) may be used for planter exoskeleton material when they become available.

The nonwoven polymer matting that is a component of the exoskeleton may optionally be comprised of fibers that are produced from recycled scrap material, such as polyethylene terephthalate (PET) beverage bottles, PET carpet fibers, or high-density polyethylene (HDPE) milk jugs.

In a preferred embodiment, the exoskeletons are fabricated by cutting the nonwoven matting into desired shapes and sizes and then coating the outside (and, optionally, the inside) surface of the matting with spray-on, two-part polyurea resin. The uncured polyurea resin penetrates about ¼ to 1 inch into the interior of the matting, and then cures around the polymer fibers, forming a stiff and durable “shell” on the matting. The characteristics of the polyurea coating may be varied depending on the desired application. For example, a very thick application of polyurea resin will penetrate about 1 inch into the matting, thereby forming a relatively strong, low permeability shell that may be suitable for larger planters that require high tensile and compressive strength of the exoskeleton to support the weight of the planter. Alternately, a relatively thin application of polyurea will penetrate about ¼-inch into the matting and cure around the individual polymer fibers, while leaving open pore spaces between the fibers. This thin application of polyurea will result in an exoskeleton that retains high permeability to gases and water, while also providing moderate structural support strength and ultraviolet (UV) light protection.

The color of the polyurea may be varied as required to provide a desired coating color to the exoskeleton. Where it is desirable to provide a deterrent to chewing animals such as mice and rabbits, sand or grit may optionally be sprinkled onto the uncured polyurea coating, where it will be bound in place when the polyurea cures. The sand or grit could also be mixed with paint and then brushed over the exoskeleton. In tests made on prototype exoskeletons, polyurea coatings with sand and grit additives have been found to be effective deterrents to chewing rodents.

In some applications, it is desirable to utilize exoskeletons having significant thermal insulation. For example, in the cooler regions of the U.S., perennial plants become dormant during cold wintertime conditions, and it is best for the plants to remain dormant throughout the winter months, even if air temperatures rise temporarily due to unusually warm weather conditions. For applications where planters are used to nurture plants under these conditions, thermal insulation may be added to the interior of the exoskeleton, thereby insulating the bedding material within the planter, which helps soil temperatures remain cool during periods of temporarily warm weather.

Polyurethane foam may be optionally used to provide thermal insulation of planter exoskeletons where this feature is advantageous. The polyurethane foam is injected into the porous and permeable nonwoven matting as a two-pail, uncured resin. Upon injection, the resin expands and cures around the polymer fibers of the matting to a form closed-cell foam insulation layer. In some cases, the foam is injected as discrete nodules so that non-foamed zones within the exoskeleton retain their porosity and permeability. In other cases, the resin may be continuously injected into the nonwoven matting to form a continuous layer within the exoskeleton, thereby resulting in a low permeability exoskeleton with a high insulation value. The foam may also be used to increase the stiffness and structural strength of the exoskeleton. Useful foam density values for this application range from about ½ to 10 pounds per cubic foot.

The planters also comprise a bottom layer comprised of a weed barrier and exoskeleton. One suitable weed-barrier material for some embodiments of the present invention is commercial weed-proof landscaping material, which is permeable to water. This landscaping material is suitable for embodiments of the present invention that are designed to allow water drainage through the bottom. Another suitable weed-barrier material that is suitable for some embodiments of the present invention is polymer sheeting, such as polyvinyl chloride (PVC) or polypropylene (PP) sheeting. These materials are impermeable to water and impenetrable by weeds, and are suitable for embodiments of the present invention that do not require water drainage through the bottom of the planter.

In an alternate embodiment, the exoskeleton may be partially or completely comprised of natural materials as a means of reducing cost and/or to increase the organic content of the planter materials. For example, the polymer fibers may be partially or completely replaced by coir, jute or cotton fibers, and the latex binder (typically comprised of synthetic latex in the polyester matting products) may be replaced by natural latex rubber binder.

The planters may be comprised of a plurality of flat exoskeleton pieces, or alternately, planters may be formed from one or more pieces of exoskeleton material that have been bent into curved shapes prior to joining these pieces together. The edges of the exoskeleton sections may be seamed with either adhesives or mechanical fasteners to form three-dimensional shapes that contain the plants and bedding material. Suitable adhesives for seaming the edges of exoskeletons include polyurethane foam, polyurea, silicone, and epoxy. Suitable mechanical fasteners include barbed pins, twine, and hook-and-loop fasteners (for example, VELCRO™).

The interior portions of the planters are filled with bedding material or “interior fill” that is selected to be lightweight, durable, hydrophilic, and nontoxic to plant roots. Examples of suitable bedding materials include bedding materials such as BIOMIX™ produced by Floating Island International, LLC of Shepherd, Mont.; peat, ground bark, rockwool, perlite, coir, jute, cellulose sponge, pumice, silica or cotton, or a or a combination of one or more of these materials. For purposes of this application, the term “rockwool” means a lightweight, porous and wooly mass of fibers that is spun out from melted pieces of basalt rock or industrial slag. Optionally, other non-hydrophilic fillers such as recycled nonwoven fiber matting, shredded rubber, or shredded scrap polymer (e.g., shredded beverage bottles or carpet) may be added to the bedding material to reduce cost or reduce weight.

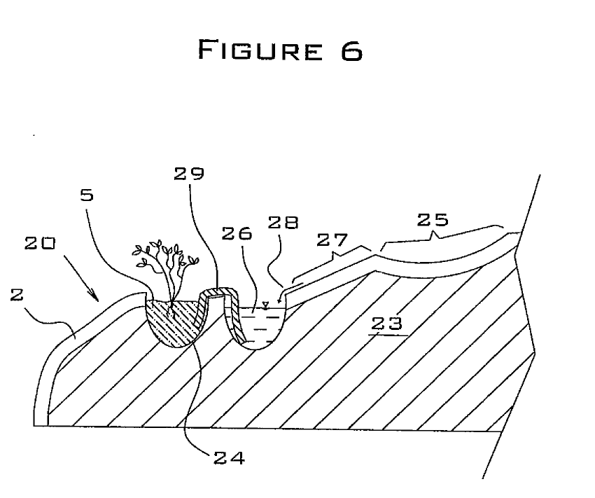

The interior fill may be inserted concentrically as in, for example, a center fill zone comprised of peat surrounded by an outer layer of rockwool. This concentric fill embodiment may be useful for optimizing water availability for plants. For example, an outer layer of water-saturated rockwool may be used to gradually supply water to a central fill zone comprised of peat by natural capillary action. This capillary effect is referred to herein as “horizontal wicking.” This aspect of the present invention is described more fully in connection with FIG. 6.

Optionally, the planters may be constructed with a flat panel rear wall so that they fit flush against a vertical wall or sloping roof. They may be attached to fences, building walls, and sloping roofs with screws, nails, bolts, or adhesives. Optional mounting plates may be attached to the back of the planters to provide sturdy attachment points.

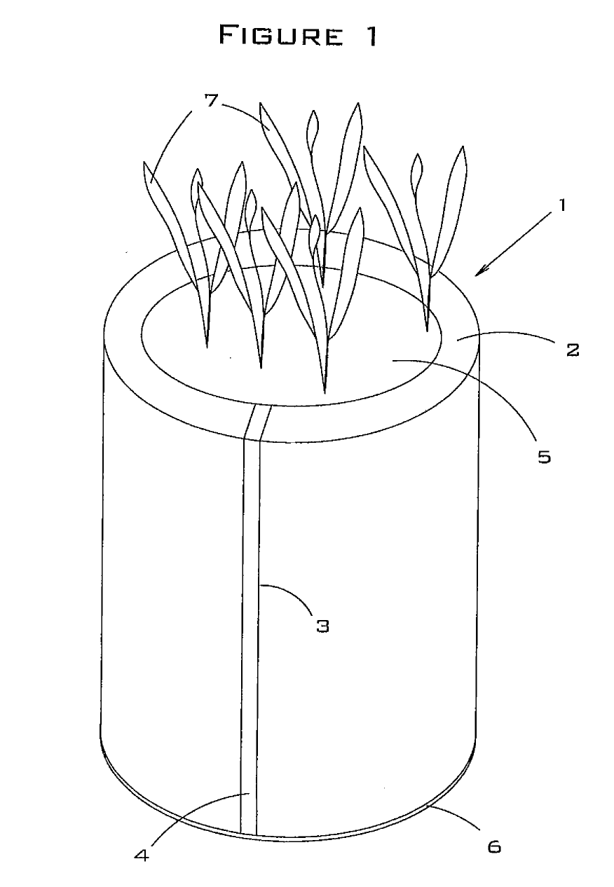

FIG. 1 is a perspective view of a first embodiment of the present invention. In this embodiment, the raised bed planter 1 is comprised of an exoskeleton 2 with a seam 3, bonding agent 4, interior fill 5, and a bottom layer 6. Plants 7 are shown growing within the raised-bed planter 1. Bonding agent 4 is used to connect and seal the adjoining edges of exoskeleton 2.

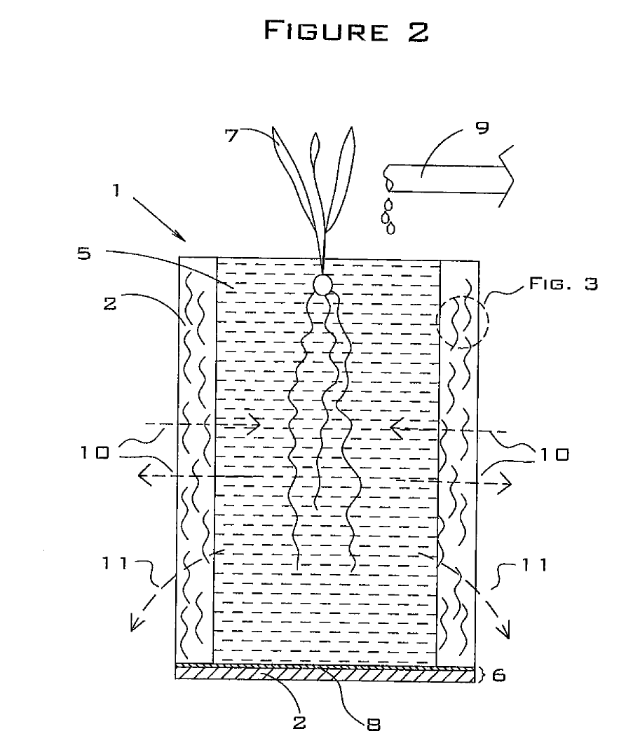

FIG. 2 is a cross-section side view of the first embodiment of the present invention, which shows the raised-bed planter 1 comprised of an exoskeleton 2, interior fill 5, plants 7, a bottom layer 6 comprising a weed barrier 8, and a bonding agent (not shown) that bonds the bottom layer 6 to the exoskeleton 2. An external water supply 9 is used to supply water to the raised-bed planter 1. Arrows 10 represent gases that pass through the permeable exoskeleton 2 from the atmosphere to the interior fill 5 and from the interior fill 5 to the atmosphere. One of these atmospheric gases is oxygen, which is necessary for plant root survival. Another of these atmospheric gases is nitrogen, which may be converted to the nutrient nitrate by the biological process of “nitrogen fixing” by fungi living within the interior fill 5.

Arrows 11 represent drainage of excess water from the interior fill 5 through the exoskeleton 2. The bottom layer 6 is designed to be impenetrable by the roots of plants 7 and also impenetrable by weeds (not shown) that would otherwise enter the interior of raised-bed planter 1 from outside, due to the weed barrier 8. If the bottom of the planter is designed to be water permeable, the weed barrier 8 may be comprised of commercial weed-proof landscaping fabric. If the bottom of the planter is designed to be impermeable to water, the weed barrier 8 may be comprised of polymer sheeting, such as polyvinyl chloride or polypropylene sheeting.

The exoskeleton 2 is optionally manufactured so as to be resistant and repellent to rodents and insects that would otherwise burrow into planter to eat the roots of plants. For example, sand can be incorporated into the coating of the exoskeleton material to discourage chewing activities by rodents. Optionally, the bottom layer 6 may be made either permeable or impermeable to water. An example of a permeable bottom layer is a composite made from a lower layer of nonwoven polymer matting and an upper layer of weed-proof nonwoven landscaping fabric. An example of an impermeable bottom layer is a composite made of nonwoven polymer matting that has been sprayed with a filling/coating of polyurea or latex.

In some applications, it is desirable for the planter 1 to provide thermal insulation for the plant roots within the structure; for instance, perennial woody plants should be kept cool during the winter dormant period in order to prevent premature growth during temporary warm periods in the winter months. For these applications, the exoskeleton may be manufactured with extra thickness and may optionally be injected with polymer foam insulation. A standard-thickness exoskeleton may have a thickness ranging from about 0.5 inch to 2 inches; an insulating exoskeleton may have a thickness ranging from about 2.5 inches to 12 inches.

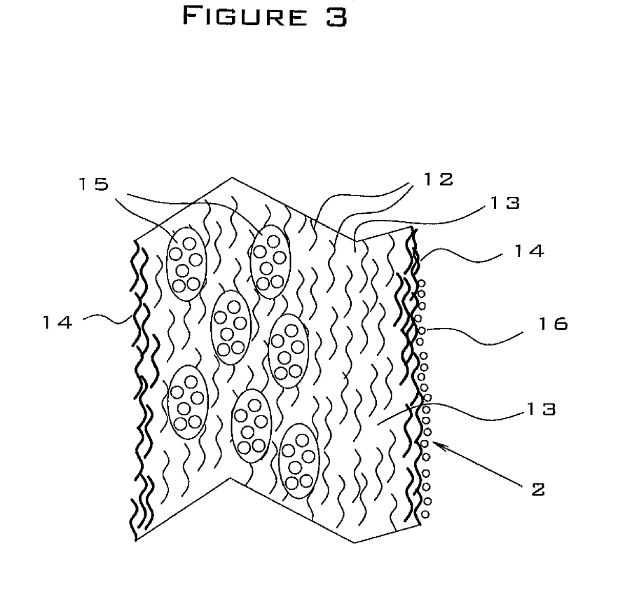

FIG. 3 is a schematic illustration of a detail of the exoskeleton 2, showing the individual nonwoven polymer fibers 12 and pore spaces 13 comprising the nonwoven fiber matting, polyurea coating 14, optional foam insulation 15, and optional sand or grit 16 used as a rodent deterrent. In this figure, the polyurea coating 14 has been applied to both the interior and exterior walls of the nonwoven fiber matting, and has coated the fibers to a depth of approximately 10% of the matting thickness. As shown, the polyurea coating 14 has formed a coating layer around individual fibers 12, but has not filled the pore spaces 13 between the fibers. This is considered to be a relatively light degree of coating (i.e., a “light coating”). The polyurea coating 14 forms rigid walls on the surfaces of the matting, increasing the rigidity of the matting, and thereby forming an exoskeleton 2 capable of supporting the weight of the planter and its contents. If more coating had been applied (i.e., a “heavy coating”), some or all of the pore spaces between adjacent fibers would have been filled, and the resulting exoskeleton would have had a lower permeability but higher tensile and compressive strengths than provided by a light coating.

Also shown in FIG. 3 are sand or grit particles 16 that are bonded to the outside surface of the polyurea coating 14. These sand or grit particles are a deterrent to animals that would otherwise chew through the exoskeleton in order to obtain access to the palatable plant roots within the planter. The sand or grit particles 16 may be attached to the polyurea coating 14 by sprinkling the particles 16 onto the uncured tacky coating 14 immediately after it has been applied.

Finally, optional foam nodules 15 are shown within the exoskeleton 2. These foam nodules 15 are comprised of polyurethane foam that has been injected under pressure as a two-part uncured resin, where it has penetrated into the central portion of the exoskeleton 2, expanded, and cured in place around the fibers 12 and into a portion of the pore spaces 13, thereby increasing the thermal insulation properties of the exoskeleton 2. The individual foam nodules 15 shown in the figure represent a “light injection” of foam. Optionally, more foam resin could be applied (a “heavy injection”), so that a continuous layer of foam is formed within the exoskeleton. The insulation value of the exoskeleton can be controlled by adjusting the amount of foam that is injected.

The materials and manufacturing methods used to produce exoskeleton 2 provide the exoskeleton with biomimetic properties. For example: (1) the permeability and porosity of the exoskeleton provide gas exchange and water drainage around the plant roots similar to the effects provided by peat soil; (2) the outer coating of the exoskeleton provides protection from UV light, insects and rodents similar to that provided by tree bark; and (3) the insulation provided by the optional injected foam nodules provides a relatively stable temperature environment for plant roots that is similar to the environment of roots growing in natural soils, whereas roots in uninsulated, prior art planters are potentially exposed to rapid unnatural and harmful temperature variations resulting from weather changes. This combination of biomimetic properties helps to provide optimal growth and survivability for plants within the planter.

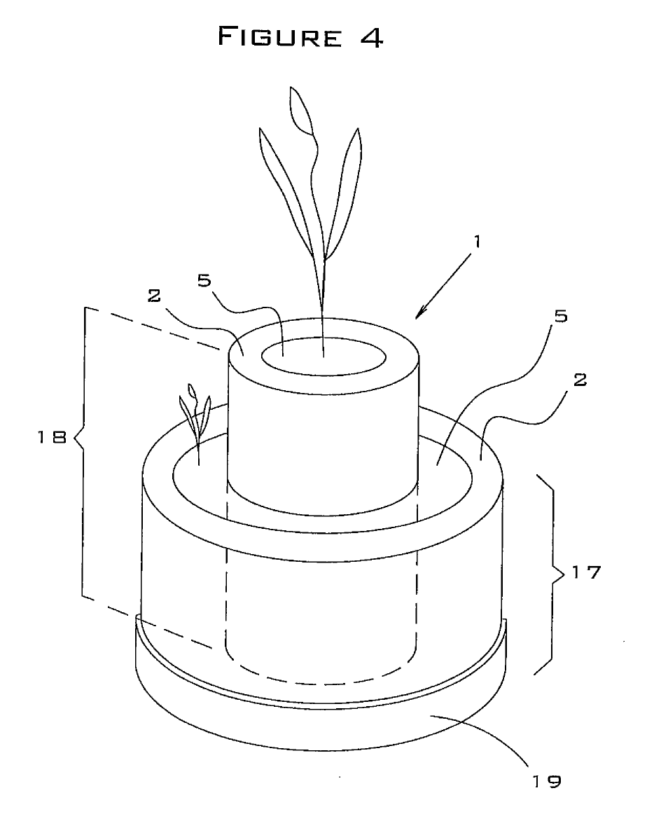

FIG. 4 is a perspective view of a second embodiment of the raised-bed planter 1, in which the planter is comprised of a short outer section 17 and a long inner section 18. Each individual section 17 and 18 is similar to the embodiment shown in FIG. 1 in that it is comprised of an exoskeleton 2 and interior fill 5. This embodiment is advantageous for certain applications because it provides for two growing environments, thereby allowing different types of plants to be grown simultaneously. For example, the outer section 17 may be heavily watered to support wetland plants, while the inner section 18 may be lightly watered to support desert plants. This embodiment also comprises an optional impermeable bottom cup 19 around the bottom portion of the outer section 17. The purpose of the bottom cup 19 is to provide a zone of water-saturated soil in the bottom of the outer section 17, which may be desirable for some plants that prefer a saturated root zone. The bottom cup 19 may alternately be installed within the interior of the outer section 17, rather than on the exterior, as shown in this drawing.

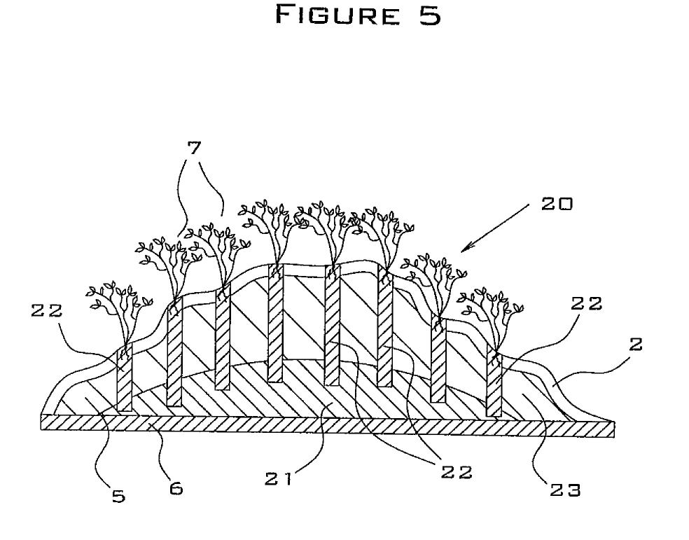

FIG. 5 is a cross-section side view of a “green rock” embodiment 20 of a raised bed planter. This embodiment is designed to have the appearance of a natural earth mound or boulder. The term “green rock” refers to the natural appearance of this embodiment. The green rock embodiment 20 is comprised of a bottom layer 6, a hydrophilic insert 21, capillary wicking channels 22, fiber wool fill 23, and an exoskeleton 2. The bottom layer 6 is comprised of a layer of exoskeleton and a weed-proof layer of landscaping material. The hydrophilic insert 21 absorbs, stores, and eventually releases water to plants 7 growing within the green rock embodiment 20. The wicking channels 22 transport water vertically upward from the hydrophilic insert 21 to plants 7 that are growing near the top of the wicking channels 22, and which grow through holes cut through the exoskeleton 2. The hydrophilic insert 21 and wicking channels 22 are comprised of materials that are lightweight, durable, hydrophilic, and nontoxic to plant roots. Examples of suitable materials include bedding materials such as BIOMIX™ produced by Floating Island International, LLC of Shepherd, Mont.; peat, ground bark, rockwool, perlite, coir, jute, cellulose sponge, pumice, silica or cotton, or a combination of one or more of these materials. The fiber wool fill 23 is preferably comprised of scrap pieces of nonwoven polymer matting that has been chopped or shredded. Alternately, the fiber wool fill 23 may be comprised of coir, jute, cotton, or other natural fibers, rockwool, fiberglass, polymer foam, shredded rubber, scraps of these materials, or combinations of these materials.

The exoskeleton 2 is preferably comprised of a combination of nonwoven polymer matting, spray-on polyurea coating, and optional injected foam insulation. Exoskeleton 2 may alternately be comprised of polyurea coating that has been sprayed directly onto the top surface of the fiber wool fill 23 during assembly of the planter. The openings in the exoskeleton where the plants grow through may optionally be sloped so that water falling onto the exoskeleton 2 flows by gravity into a nearby wicking channel 22, thereby supplying water to plants 7 and hydrophilic insert 21.

FIG. 6 is a partial cross section view of a portion of an alternate embodiment of a green rock planter 20 that uses a horizontal wicking system to supply water for plants. In this embodiment, the bedding pockets 24 are formed by cutting holes through the exoskeleton 2 and into the interior portion of the structure, and then inserting bedding material 5 into the bedding pockets 24. The horizontal wicking system works as follows: rainwater falling onto the planter accumulates in collection basin 25, which is a depression that collects water from a relatively large portion of the planter surface. Water flows by gravity from the collection basin 25 to the reservoir 26 through the runoff channel 27, as indicated by arrow 28. Reservoir 26 is lined with an impermeable liner (not shown) to prevent water seepage into the interior portion of the planter. Water is transported from the reservoir 26 to the bedding pocket 24 via capillary wicking by means of wicking component 29. The wicking component 29 may be comprised of compressed rockwool, cotton cloth, or other similar hydrophilic material, Alternately, the wicking component 29 may be comprised of polymer pipe (one- to four-inch diameter) that has been packed with compressed rockwool, cotton fibers, or other similar hydrophilic material. Although the wicking component 29 is shown to be exposed and visible in FIG. 6, it may alternately be constructed within or underneath the exoskeleton 2.

Wicking experiments were conducted at the Floating Island International Research Facility in Shepherd, Mont. during the period May 20-23, 2008. The purpose of the experiments was to empirically determine one water flow rate for one practical size of wicking component under conditions expected to be typical in a raised bed planter with an internal reservoir and wicking component. The experimental conditions are described below.

The wicking component was a rectangular enclosed channel (e.g., a rectangular “tube”) having an internal width of 2.5 inches, an internal height of 1.0 inch, and an internal length of 24.0 inches. The wicking tube was packed with 0.8 pound of medium-grade horticultural wool rockwool manufactured by Amerrock Products LP of Nolanville, Tex. The resulting packed rockwool density in the wicking tube was about 23 pounds per cubic foot (dry weight). One end of the wicking tube was placed in a bucket of water (the “reservoir bucket”), and the other end of the wicking tube was suspended over a second empty bucket (the “receiving bucket”). The wicking tube was constructed in three connected segments so that the first 8 inches of length rose diagonally from the reservoir bucket, the second 8 inches of length was positioned horizontally, and the third 8 inches dropped diagonally downward toward the receiving bucket. Maximum vertical water rise in the wicking tube was 4.0 inches, as measured from the water level of the reservoir bucket to the centerline of the wicking tube at maximum elevation. Water level in the reservoir bucket was kept constant during the experiment. A time interval of 15.5 hours was measured between the times when water first started dripping into the receiving bucket until a volume of 16 fluid ounces was collected in the receiving bucket, resulting in a calculated flow rate of 1.03 fluid ounces per hour, or about 0.19 gallons per day.

The wicking system of the present invention has several advantages over conventional prior art wicking systems that are comprised of an external reservoir and a non-encapsulated wick. These advantages include:

(1) The water reservoir of the present invention, being contained within the structure of the raised bed planter, contributes significant thermal mass to the planter, thereby tending to keep the internal temperature of the planter relatively constant during short-term changes in external air temperature. This temperature-regulating feature is beneficial to plant growth and health.

(2) The wicking material (e.g., compacted rockwool), being contained within a low-permeability shell or tube, is protected from evaporative losses. Conversely, conventional prior-art woven wicks, being exposed to the atmosphere, are prone to evaporative losses, resulting in a waste of reservoir water.

(3) The reservoir, being covered by the exoskeleton, and the wicking component, being contained within a tube and covered by the exoskeleton, are both sheltered from sunlight, thereby preventing the growth of photosynthesizing algae on and within the wetted areas. Prior art wicking systems may comprise reservoirs and wicks that are exposed to sunlight and are therefore conducive to the growth of photosynthesizing algae. These algae may result in a reduction of capillary flow rate, production of odors, and an unsightly appearance.

(4) The greater cross-sectional flow area of the present invention's wicking tube (e.g., 2.5 square inches for the tube used in the experiment) as compared to conventional woven wicks makes the wicking tubes less prone to plugging by undesirable bacterial biofilm growth.

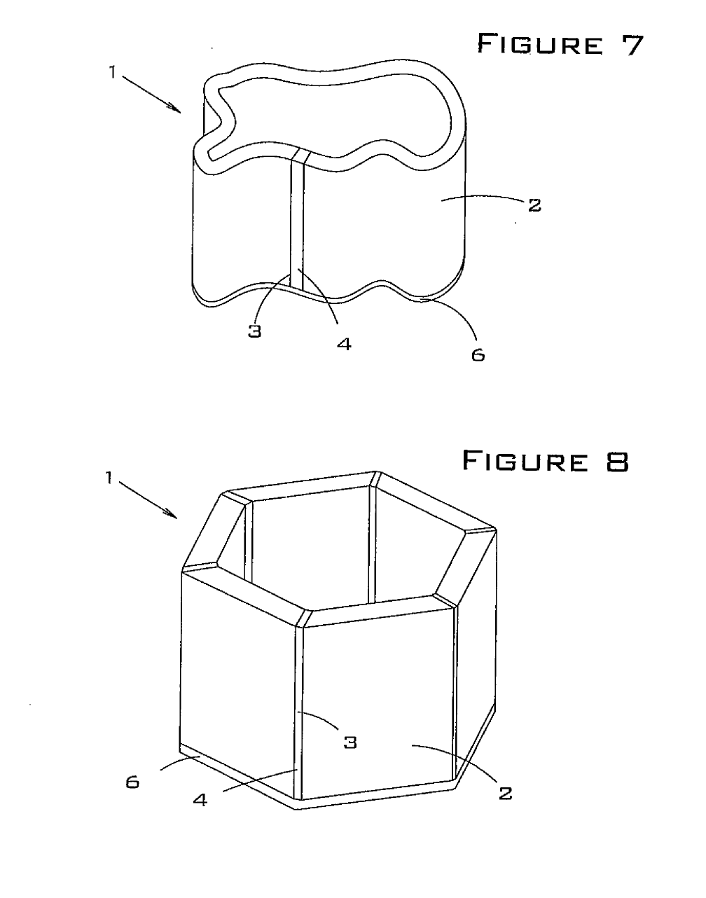

FIG. 7 is a perspective view of an alternate embodiment of a raised bed planter 1 that illustrates how the exoskeleton may be bent into a freeform shape for aesthetic purposes. This embodiment is similar in construction to the first embodiment, except for the shape of the exoskeleton 2. Exoskeleton 2 may be shaped by hand or may be produced by forming it into the inside of a hollow frame mold. The embodiment shown in FIG. 7 is constructed similarly to the embodiment shown in FIG. 1, with a seam 3, bonding agent 4, and bottom layer 6 comprised of weed barrier (not shown).

FIG. 8 is a perspective view of an alternate embodiment in which the raised bed planter l has flat sides that have been assembled to form a geometric shape. This embodiment may be produced by seaming together multiple flat sheets of exoskeleton 2. Hybrid shapes (not shown) may be constructed by utilizing combinations of freeform, curved, and flat pieces of matting in the same planter. The embodiment shown in FIG. 8 is similar in construction to the embodiment shown in FIGS. 1 and 7, with one or more seams 3, bonding agent 4, and bottom layer 6 comprised of weed barrier (not shown).

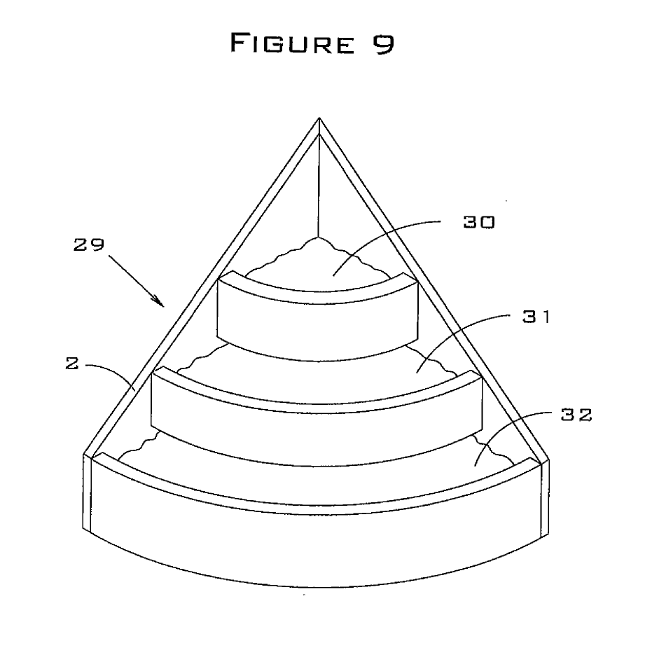

FIG. 9 is a perspective view of a multi-level planter 29 with three planting beds, including an upper planting bed 30, a middle planting bed 31, and a lower planting bed 32. In this embodiment, the exoskeleton 2 is shaped so as to fit into a corner of a building, fence, or similar structure with a corner. The embodiment shown in FIG. 9 is similar in construction materials and methods to the previously described embodiments, except that the exoskeleton 2 may be made stiffer and stronger in order to support the extra weight of the multiple stacked planting beds 30, 31 and 32. In addition to the strength provided by spraying polyurea coating onto the interior and exterior surfaces of the exoskeleton 2, extra support may optionally be provided by injecting strengthening materials into the central portions of exoskeleton 2. Examples of suitable strengthening materials include shotcrete, polyurethane foam, polyurethane, polyurea, construction adhesive, silicone and plastic wood filter. All of these materials are injected into the matting as uncured liquids, after which they cure in place and become hard. The matting is approximately 95% pore space prior to injecting the strengthening material; the required amount of strengthening can be regulated by controlling the volume of pore space that is filled with injected liquid. More injected material results in more strength for the exoskeleton with a corresponding decrease in porosity and permeability. Optionally, the planter may be designed to be free standing, rather than attached to a wall or fence, by injecting sufficient stiffening material into the exoskeleton 2. Optionally, two, three or four planters 25 shown in FIG. 9 may be assembled to form a partial or complete circle when viewed from above (not shown).

FIG. 10 is a cross-section side view of a multi-level planter 29 having three growing levels (the same embodiment shown in FIG. 9). The optional internal baffles 33 may be used to reduce the overall weight of the structure. Bedding soil is placed into the upper bed 30, middle bed 31, and lower bed 32 to grow plants 7. Optional drain tubes 34 may be used to drain excess water from the upper bed 30 to the middle bed 31 and from the middle bed 31 to the lower bed 32. The drain tubes 34 may be comprised of flexible or stiff polymer tubing having an internal diameter from about ½-inch to about two inches, depending on the size of the planting beds. Optional impermeable bed liners 31 may be installed along the inner walls and the bottom of each bed in order to prevent water from escaping through the permeable walls and bottoms of the beds.

Excess water is eventually captured in the internal tray 36, where it remains until it is drained through outlet tubing 37 when the drain valve 38 is temporarily opened. The internal baffles 33 may be comprised of expanded polystyrene, polyurea-coated nonwoven matting, or polyurethane foam. The bed liners 35 may be comprised of polyurethane, polyurea, or polypropylene and may be sprayed on as an uncured liquid (it cures in place within less than 60 seconds at 80 degrees Fahrenheit) to form a water-impermeable coating. Alternately, bed liners 35 may be preformed by molding and slipped into position. Portions of the exoskeleton may optionally be covered with outdoor carpeting to reduce moisture losses and/or for decorative purposes.

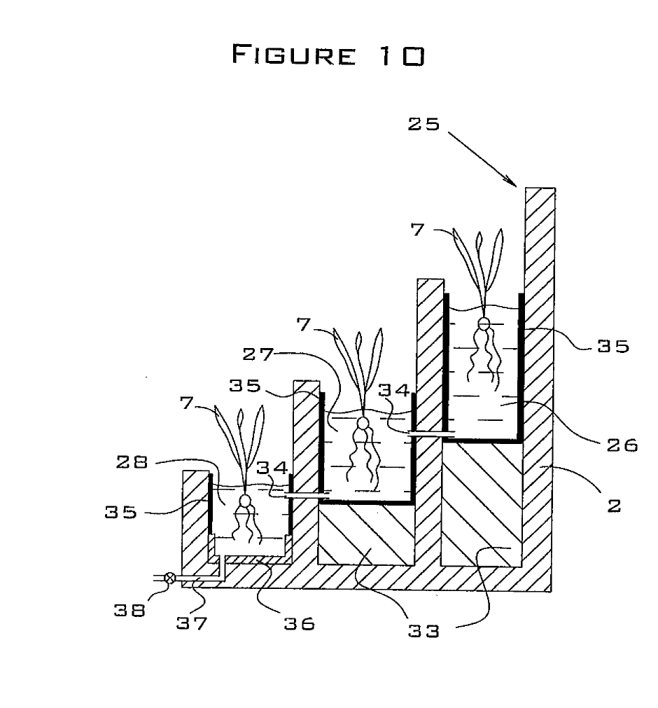

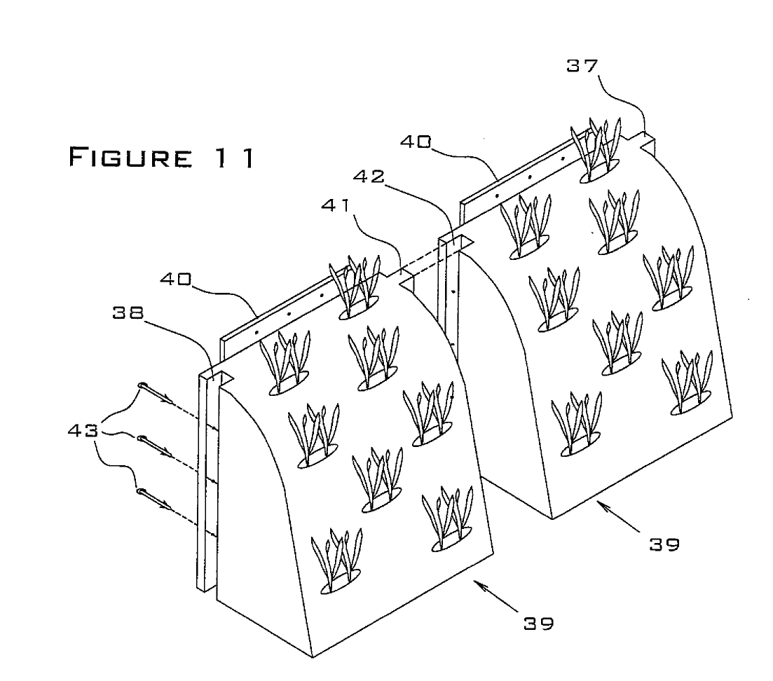

FIG. 11 is an exploded perspective view of two interlocking planter units 39 that may be joined to form a free-standing green wall or a wall covering for an existing wall or fence. Each planter unit 39 comprises an optional mounting plate 40 to attach the planters 39 to an existing wall, fence or roof (not shown). The planter units 39 are locked together via a tongue 41 that fits into a groove 42 in each adjoining planter unit 39. Optional single-ended barbed pins 43 may be installed to add strength to the assembled planter structure. Although two adjoining units are shown in FIG. 11, any number of units may be connected in the manner shown. The figure shows an array of interlocking planters 39 that are connected horizontally; a similar interlocking method may be employed to form a vertical array of stacked planters (not shown).

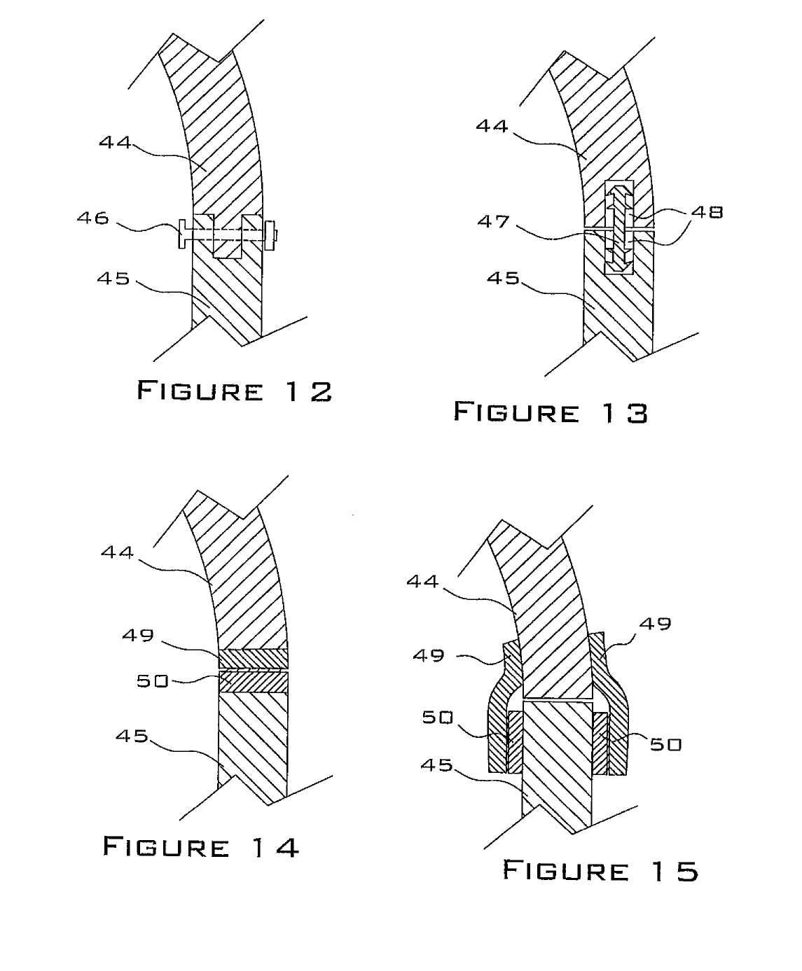

In some cases, it may be advantageous to transport and/or sell the planters in an unassembled condition. In these cases, the planters will be modified so that they can be assembled easily by a customer or dealer. FIGS. 12 through 14 illustrate alternate methods of joining seams that may be easily accomplished without the use of adhesives or bonding agents.

FIG. 12 is a partial plan cross-section view of two exoskeleton segments of a planter that have been joined by a tongue-and groove fitting that has been machined into the adjoining edges of two sheets of exoskeleton. As shown in FIG. 12, the first exoskeleton segment 44 comprises a protrusion or tongue, and the second exoskeleton segment 45 comprises a groove, wherein the tongue and groove shapes are machined into the edges of the exoskeleton segments 44 and 45. The tongue of exoskeleton segment 44 and the groove of exoskeleton segment 45 form an interlocking friction-fit connection between the two segments of exoskeleton 44 and 45. Also shown is an optional locking pin assembly 46, which may be used to add strength to the tongue-and groove connection if required.

FIG. 13 is a partial plan cross-section view of exoskeleton segments of a planter that have been joined by a double-ended barbed pin 47 that attaches to the inner walls of edge holes 48 that are drilled or machined into first exoskeleton segment 44 and second exoskeleton segment 45.

FIG. 14 is a partial plan cross-section view of two exoskeleton segments of a planter that have been joined by hook-and-loop fasteners. An example of a hook-and-loop fastener is VELCRO™ manufactured by Velcro USA of Manchester, N.H. As shown in this figure, the hook portion 49 of a hook-and-loop fastener is glued to an edge first exoskeleton segment 44, and the loop portion 50 of a hook-and-loop fastener is glued to an edge of second exoskeleton segment 45. When the two exoskeleton segments 44 and 45 are pressed together as shown, the hook-and-loop fastener will join the two matting sheets.

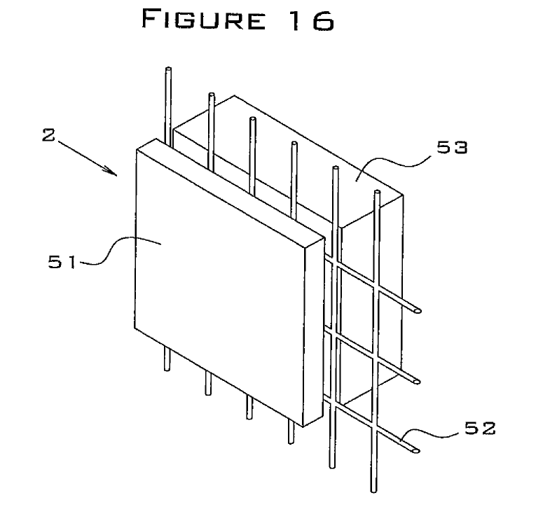

FIG. 15 is an alternate embodiment of the hook-and-loop fastener system shown in FIG. 14, in which the hook portions 49 and loop portions 50 of a hook-and-loop fastener are each glued to the side of an exoskeleton segment rather the end of an exoskeleton segment. There are numerous other methods of attaching matting sheets without adhesives that are practical for this application such as sewing or stapling.

FIG. 16 is an exploded view of an alternative construction method for the exoskeleton 2. This embodiment comprises an outer layer of outdoor carpet 51, a center layer of fencing material 52, and an inner layer of nonwoven polymer matting 53.

The purpose of the fencing material 52 is to add rigidity to the exoskeleton in order to reduce buckling or sagging of the exoskeleton 2, particularly when the exoskeleton is used to contain wet or otherwise heavy soil or other plant growth media. Fencing material 52 may be comprised of steel, galvanized steel, polymer-coated steel, aluminum, fiberglass, or thermoplastic polymers such as PVC or HDPE, or recycled scrap thermoplastic polymer material. Although the fencing material 52 is shown in FIG. 16 to be positioned between the other layers of material, it may optionally be placed on the exterior or interior surface of the exoskeleton 2.

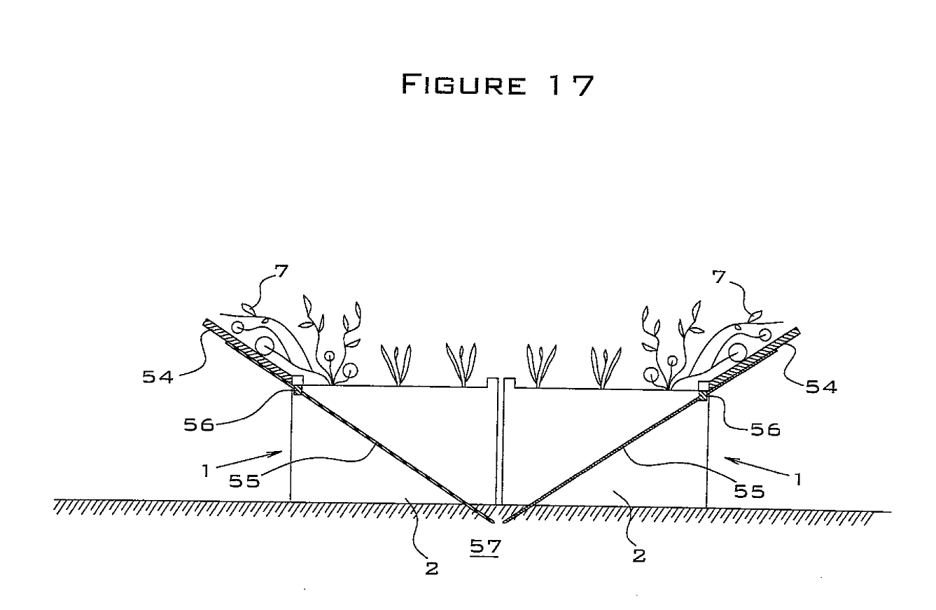

FIG. 17 is a cross-section view of a plurality of planters, assembled in a circular array, that comprises optional “wings” or extensions. As shown in the drawing, each wing 54 is held in place by a support rod 55 that passes through a support bracket 56. The support rod may pass in between adjacent planters, through the hydrophilic fill material, or through the exoskeleton of one or more planters. The support rod may optionally be driven into the ground 57 (as shown). One purpose of the wings 54 is to support the weight of growing plants 7, particularly if the plants bear heavy fruits or vegetables. A second purpose of the wings 54 is to prevent animal pests, such as rabbits, from hopping up onto the planter. A third purpose of the wings 54 is to capture rainfall and irrigation sprinkler water and then funnel this water to the plants 7 growing within the planter. Although shown as an array of planters in FIG. 17, the wings 54 may be used with a single planter.

The wing 54 may be comprised of any suitably lightweight and strong material, such as landscaping fabric, woven or nonwoven polymer sheeting, metal sheeting or metal fencing. One example of a suitable metal fencing is woven ten-gauge galvanized steel wire with openings of about four inches by four inches. This product is typically called “sheep fence.” Another example of a suitable metal fencing is ten-gauge galvanized steel wire with openings of about two inches by four inches. This product is typically called “horse fence.” For applications in which the wings 54 are used to convey water, the wings 54 are preferably made from an impermeable material. Support rods 55 are preferably spaced at suitable intervals around the planter in order to give adequate support for the wings 54 and the weight of plants 7 and water (not shown) that are supported by the wings 54. For example, a circular planter having a circumference of twenty-four (24) feet may require a total of eight (8) support rods in order to support a wing that extends around the entire perimeter of the planter. The support rods 55 may be comprised of wood, steel, aluminum, fiberglass, PVC or HDPE.

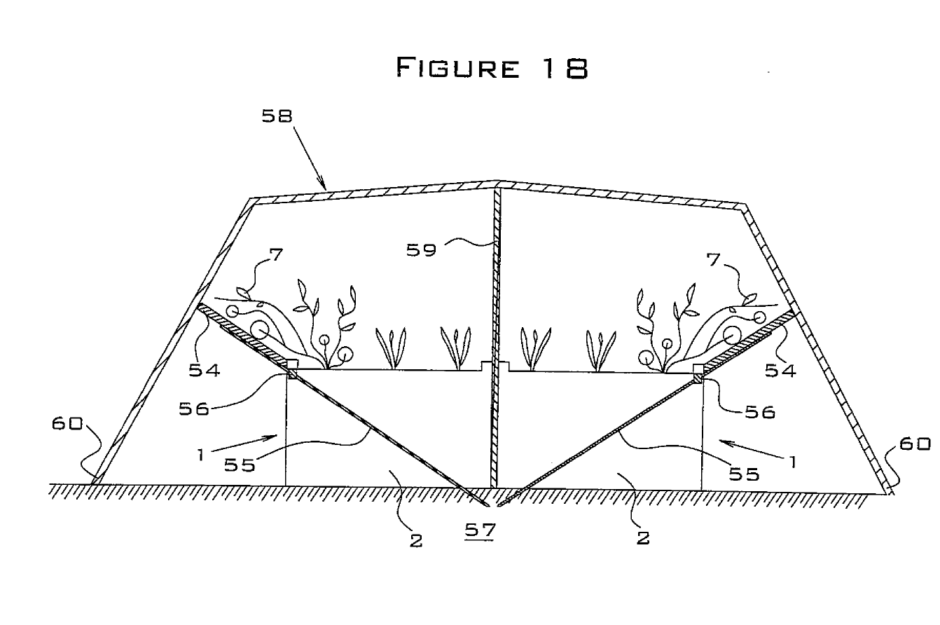

FIG. 18 is a cross-section view of a circular array of planters that comprises an optional removable greenhouse cover. As shown in the drawing, the greenhouse cover 58 is supported around the perimeter of the planters 1 by wings 54 and is supported at the top by a center pole 59. Although FIG. 18 shows a single center pole in between adjacent planters, the greenhouse cover 58 could also be supported by a single center pole that extends upward through the center of a single planter or by one or more vertical poles that extend upward through a single planter or in between two or more planters. Although shown in relation to a plurality of planters, the greenhouse cover 58 may be used with a single planter as well.

In FIG. 18, the lower edges 60 of the greenhouse cover 58 extend to or near to the ground surface. The purpose of the greenhouse cover 58 is to trap heat while simultaneously allowing sunlight to pass through to plants growing in the raised bed planter 1 located within the space 61 contained within the greenhouse cover 58. The greenhouse cover 58 may be comprised of a variety of transparent or translucent materials, such as polyethylene sheeting, fiberglass, acrylic or glass panels, woven polypropylene fabric, woven fabric made from a natural fiber (such as cotton), and/or polymer netting. The greenhouse cover 58 may optionally be installed only during the cooler portions of the growing season and removed during the warmer portions of the growing season. In addition to retaining heat, the greenhouse cover may be useful in some applications for providing protection for the plants from damaging winds, precipitation, insects, birds, and other animals.

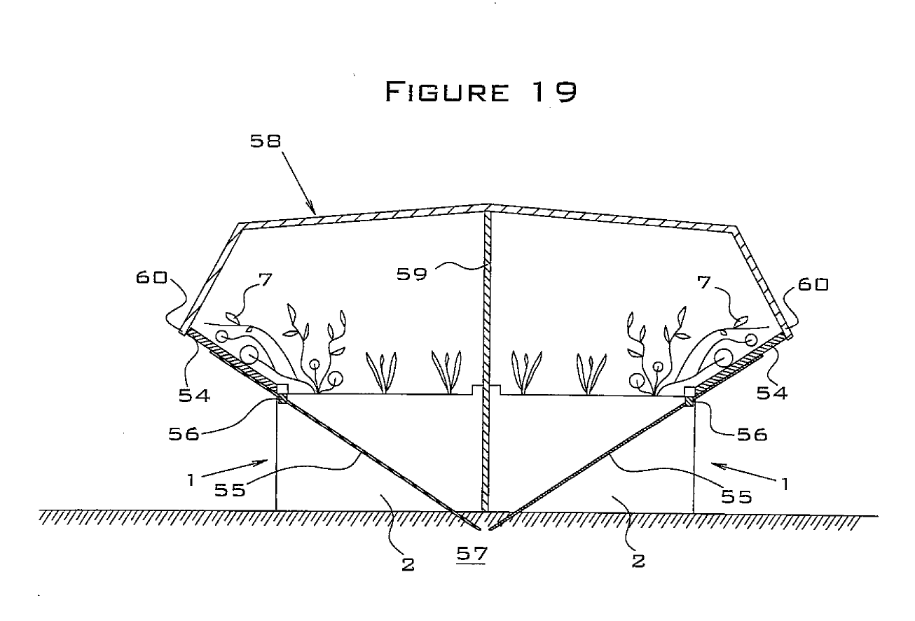

FIG. 19 is a cross-section view of a planter that comprises an alternative embodiment of an optional removable greenhouse cover. As shown in the drawing, the short-sided greenhouse cover 62 is similar to the greenhouse cover 58 shown in FIG. 18 except that the lower edges 60 of the short-sided greenhouse cover 62 extend only to the outer edges of the wings 54. This embodiment may be cheaper to manufacture than the greenhouse cover 58 shown in FIG. 18 because less material is required.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A raised bed planter comprising:
(a) a porous and permeable load-bearing exoskeleton comprised of nonwoven polymer matting and a spray-on polymer coating;
(b) a core section comprised of hydrophilic bedding fill material; and
(c) a bottom layer that serves as a weed barrier.

2. The raised bed planter of claim 1, wherein the exoskeleton further comprises injected foam insulation.

3. The raised bed planter of claim 1, wherein the exoskeleton comprises seams between adjoining layers of nonwoven polymer matting, and wherein the seams are joined with a bonding agent.

4. The raised bed planter of claim 1, wherein the exoskeleton comprises seams between adjoining layers of nonwoven polymer matting, and wherein the seams are joined with mechanical fasteners.

5. The raised bed planter of claim 1, wherein the exoskeleton further comprises sand or grit to deter chewing damage from rodents.

6. The raised bed planter of claim 1, further comprising an exterior layer of indoor/outdoor carpeting to add protection against wind desiccation while providing a cosmetic benefit.

7. The raised bed planter of claim 1, further comprising wicking channels that transport water at a controlled rate in any direction to plants growing within the planter.

8. The raised bed planter of claim 1, further comprising wicking components that transport water at a controlled rate in any direction to plants growing within the planter.

9. The raised bed planter of claim 7 or 8, further comprising a reservoir for storing the water that is transported by the wicking channels and/or wicking components.

10. The raised bed planter of claim 1, wherein the nonwoven polymer matting is comprised of polyester fibers that are intertwined to form a randomly oriented blanket.

11. The raised bed planter of claim 10, wherein a water-based latex binder is baked onto the polyester fibers to increase stiffness and durability of the blanket.

12. The raised bed planter of claim 1, wherein the nonwoven polymer matting is comprised of recycled scrap material.

13. The raised bed planter of claim 12, wherein the recycled scrap material is selected from the group consisting of polyethylene terephthalate beverage bottles, polyethylene terephthalate carpet fibers, and high-density polyethylene milk jugs.

14. The raised bed planter of claim 1, wherein the spray-on polymer coating is a two-part polyurea resin.

15. The raised bed planter of claim 2, wherein the injected foam insulation is polyurethane foam.

16. The raised bed planter of claim 1, wherein the bottom layer is comprised of a weed barrier material and a layer of porous and permeable load-bearing exoskeleton comprised of nonwoven polymer matting and a spray-on polymer coating.

17. The raised bed planter of claim 1, wherein the nonwoven polymer matting of the exoskeleton is replaced with a nonwoven matting that is partially or completely comprised of one or more natural materials.

18. The raised bed planter of claim 17, wherein the natural material(s) is/are selected from the group consisting of coir, jute and cotton.

19. The raised bed planter of claim 1, wherein the exoskeleton is comprised of a plurality of pieces of exoskeleton that are bonded together with an adhesive.

20. The raised bed planter of claim 1, wherein the exoskeleton is comprised of a plurality of pieces of exoskeleton that are fastened together with mechanical fasteners.

21. The raised bed planter of claim 1, wherein the hydrophilic bedding fill material is lightweight, durable, hydrophilic and nontoxic to plant roots.

22. The raised bed planter of claim 21, wherein the hydrophilic bedding fill material comprises peat, ground bark, rockwool, perlite, coir, jute, cellulose sponge, pumice, silica and/or cotton.

23. The raised bed planter of claim 22, wherein a non-hydrophilic filler is added to the bedding material to reduce cost and/or weight.

24. The raised bed planter of claim 1, wherein the planter is constructed with a flat panel rear wall for installation on a wall, roof, fence or building.

25. The raised bed planter of claim 16, wherein the weed barrier material is permeable to water.

26. The raised bed planter of claim 16, wherein the weed barrier material is impermeable to water.

27. The raised bed planter of claim 5, wherein the sand or grit is adhered to the exoskeleton by sprinkling it onto uncured tacky polymer coating immediately after it has been applied to the nonwoven polymer matting.

28. The raised bed planter of claim 5, wherein the sand or grit is mixed with paint and brushed over the exoskeleton.

29. The raised bed planter of claim 1, further comprising foam nodules that are injected into the exoskeleton.

30. The raised bed planter of claim 1, wherein the planter comprises an inner section and an outer section, thereby providing two different growing environments.

31. The raised bed planter of claim 30, wherein the outer section comprises a bottom and the planter further comprises a bottom cup that is impermeable to water and that provides a zone of water-saturated soil in the bottom of the outer section.

32. The raised bed planter of claim 1, further comprising a hydrophilic insert, capillary wicking channels and fiber wool fill;
wherein each wicking channel has a top portion; and
wherein the wicking channels transport water vertically upward from the hydrophilic insert to plants that are growing near the top portion of the wicking channels and that grow through holes cut through the exoskeleton.

33. The raised bed planter of claim 32, wherein the hydrophilic insert and wicking channels are comprised of materials that are lightweight, durable, hydrophilic, and nontoxic to plant roots.

34. The raised bed planter of claim 32, wherein the fiber wool fill is comprised of scrap pieces of nonwoven polymer matting that has been chopped or shredded.

35. The raised bed planter of claim 32, wherein the fiber wool fill is comprised of coir, jute, cotton, rockwool, fiberglass, polymer foam, shredded rubber, or any combination of these materials.

36. The raised bed planter of claim 32, wherein the holes through which the plants grow are sloped so that water falling onto the exoskeleton flows by gravity into a nearby wicking channel, thereby supplying water to the plants and the hydrophilic insert.

37. The raised bed planter of claim 1, further comprising a horizontal wicking system.

38. The raised bed planter of claim 37, wherein bedding pockets are formed by cutting holes through the exoskeleton;
wherein the horizontal wicking system comprises a collection basin, a runoff channel, and a reservoir; and
wherein water is transported from the reservoir to the bedding pocket by a wicking component.

39. The raised bed planter of claim 38, wherein the wicking component is comprised of compressed rockwool, cotton cloth, or other hydrophilic material.

40. The raised bed planter of claim 38, wherein the wicking component is comprised of polymer pipe that has been packed with compressed rockwool, cotton fibers, or other hydrophilic material.

41. The raised bed planter of claim 39 or 40, wherein the wicking component is constructed within or underneath the exoskeleton.

42. The raised bed planter of claim 1, wherein the planter comprises multiple planting beds at different levels relative to the bottom layer.

43. The raised bed planter of claim 42, wherein the exoskeleton is shaped so as to fit into a corner of a building, fence, or any other structure with a corner.

44. The raised bed planter of claim 42, wherein the exoskeleton further comprises a strengthening material, and wherein the strengthening material is selected from the group consisting of shotcrete, polyurethane foam, polyurethane, polyurea, construction adhesive, silicone and plastic wood filler.

45. The raised bed planter of claim 42, wherein the planter has an overall weight, and wherein the planter further comprises internal baffles to reduce the overall weight of the planter.

46. The raised bed planter of claim 45, wherein the internal baffles are comprised of polystyrene, polyurea-coated nonwoven polymer matting, or polyurethane foam.

47. The raised bed planter of claim 42, further comprising drain tubes that drain excess water from one planting bed to a lower planting bed.

48. The raised bed planter of claim 47, wherein one of the planting beds is the lowest planting bed, and wherein water that drains through the drain tubes to the lowest planting bed is drained through outlet tubing when a drain valve is temporarily opened.

49. The raised bed planter of claim 42, wherein each planting bed comprises inner walls and a bottom; and
wherein each planting bed comprises impermeable bed liners installed along the inner walls and the bottom of the planting bed to prevent water from escaping from one planting bed to another.

50. The raised bed planter of claim 49, wherein the bed liners are comprised of polyurethane, polyurea, or polypropylene.

51. The raised bed planter of claim 1, wherein portions of the exoskeleton are covered with outdoor carpeting to reduce moisture losses and/or for decorative purposes.

52. The raised bed planter of claim 1, wherein each raised bed planter forms an interlocking planter unit that is joined to another interlocking planter unit by means of a tongue that fits into a groove in an adjoining interlocking planter; and
wherein the interlocking planter units are attached to a wall, fence or roof with a mounting plate that is attached to the interlocking planter units.

53. A raised bed planter comprising:
(a) an exoskeleton comprised of a layer of outdoor carpet, a layer of fencing material, and a layer of nonwoven polymer matting;
(b) a core section comprised of hydrophilic bedding fill material; and
(c) a bottom layer that serves as a weed barrier.

54. The raised bed planter of claim 53, wherein the fencing material is comprised of steel, galvanized steel, polymer-coated steel, aluminum, fiberglass, a thermoplastic polymer and/or recycled scrap thermoplastic materials.

55. The raised bed planter of claim 1 or 53, further comprising one or more wings;
wherein each wing is held in place by a support rod that passes through a support bracket;
wherein the support bracket is located in, on or directly adjacent to the exoskeleton of the planter; and
wherein the wing extends outward from the exoskeleton.

56. The raised bed planter of claim 55, wherein the wing is comprised of landscaping fabric, woven or nonwoven polymer sheeting, metal sheeting or metal fencing.

57. The raised bed planter of claim 55, wherein the support rod is comprised of wood, steel, aluminum, fiberglass, polyvinyl chloride, or high-density polyethylene.

58. The raised bed planter of claim 55, further comprising a removable greenhouse cover;
wherein the planter has a center;
wherein the greenhouse cover is supported by the wings that extend outward from the exoskeleton of the planter and by at least one vertical pole that extends from the ground surface upward through the center of the planter or in between one or more adjacent planters; and
wherein the greenhouse cover extends downward to or near to the ground surface.

59. The raised bed planter of claim 58, wherein the greenhouse cover is comprised of polyethylene sheeting, fiberglass, acrylic or glass panels, woven polypropylene fabric, or polymer netting.

60. The raised bed planter of claim 58, further comprising a removable greenhouse cover;
wherein the planter has a center;
wherein the greenhouse cover is supported by the wings that extend outward from the exoskeleton of the planter and by at least one vertical pole that extends from the ground surface upward through the center of the planter or in between one or more adjacent planters;
wherein each wing has an outer edge; and
wherein the greenhouse cover extends downward to the outer edges of the wings.

61. The raised bed planter of claim 60, wherein the greenhouse cover is comprised of polyethylene sheeting, fiberglass, acrylic or glass panels, woven polypropylene fabric, woven fabric made from a natural fiber, or polymer netting.
